(19) United States
(12) Patent Application Publication
(10) Pub. No.: US 2024/0420498 A1
(43) Pub. Date: Dec. 19, 2024

(54) TABLE-IMAGE RECOGNITION DEVICE, NON-TRANSITORY COMPUTER-READABLE STORAGE MEDIUM, AND TABLE-IMAGE RECOGNITION METHOD

(71) Applicant: Mitsubishi Electric Corporation, TOKYO (JP)

(72) Inventor: Kosuke NAKAMURA, Tokyo (JP)

(73) Assignee: Mitsubishi Electric Corporation, TOKYO (JP)

(21) Appl. No.: 18/820,950

(22) Filed: Aug. 30, 2024

Related U.S. Application Data
(63) Continuation of application No. PCT/JP2022/016788, filed on Mar. 31, 2022.

(51) Int. Cl. G06V 30/413; G06V 10/764; G06V 10/82; G06V 30/182; G06V 30/19; G06V 30/196; G06V 30/262; G06V 30/412

(52) U.S. Cl. CPC G06V 30/413; G06V 10/764; G06V 10/82; G06V 30/1823; G06V 30/19127; G06V 30/196; G06V 30/274; G06V 30/412

(57) ABSTRACT

A table-image recognition device includes: an object extracting unit that extracts a plurality of objects included in a table; a set determination unit that determines whether or not every pair consisting of two objects selected from the plurality of objects is a set constituting a component specified by a column and a row of the table; a same-row determination unit that determines whether or not the objects of each pair share a same row; a same-column determination unit that determines whether or not the two objects of each pair share a same column; and a structure determining unit that determines a structure of the table by specifying the row and column to which each object belongs on the basis of the determination result.

### CROSS REFERENCE TO RELATED APPLICATION

This application is a continuation application of International Application No. PCT/JP2022/016788 having an international filing date of Mar. 31, 2022, which is hereby expressly incorporated by reference into the present application.

### BACKGROUND OF THE INVENTION

### 1. Field of the Invention

The disclosure relates to a table-image recognition device, a non-transitory computer-readable storage medium, and a table-image recognition method.

### 2. Description of the Related Art

Conventionally, table-image recognition techniques have been used to recognize tables shown in images.

With the conventional table-image recognition techniques, when a table includes elements other than character strings such as images or figures including, for example, arrows, triangles, and rectangles, the character string area and the image or figure area are recognized separately, and rectangular areas surrounding the respective elements are specified; when the rectangular areas overlap each other, the elements having overlapping rectangular areas are treated as a single element. Then, the rows and columns to which the elements belong are identified on the basis of separately detected borders, and the structure of the table is analyzed (refer to, for example, PTL 1).
Patent Literature 1: Japanese Patent Application Publication No. 2017-084012

### SUMMARY OF THE INVENTION

The conventional table-image recognition technique unfortunately cannot correctly recognize the structure of a complicated table in which many elements other than character strings, such as images or figures, for example, arrows, triangles, and rectangles, as a road map are included, many elements are arranged across the columns or rows, or clearly visible borders are not included.

In particular, combinations of elements drawn at positions far apart from each other, such as an image or figure and a character string describing the content of the image or figure, should be analyzed as being a single semantic element belonging to a same row or column; however, the conventional method allocates such elements to different rows and columns.

The process of finally defining the rows and columns of the cells to which the elements belong assumes that the borders be clearly drawn; therefore, the conventional technique cannot be applied to tables with light colored or unclear borders.

Accordingly, it is an object of one or more aspects of the disclosure is to acquire the correct structure of a complicated table.

A table-image recognition device according to an aspect of the disclosure includes: a processor to execute a program; and a memory to store the program which, when executed by the processor, performs processes of, analyzing a table image representing a table to extract a plurality of objects included in the table; specifying a plurality of pairs each consisting of two objects selected from the extracted objects; performing set determination to determine whether or not the pairs are each a set constituting a component of the table; performing same-row determination to determine whether or not the objects of each of the pairs shares a same row; performing same-column determination to determine whether or not the objects of each of the pairs shares a same column; and determining a structure of the table by specifying a row and a column to which each of the objects belongs from a result of the set determination, a result of the same-row determination, and the a of same-column result determination.

A non-transitory computer-readable storage medium storing a program according to an aspect of the disclosure causes a computer to execute processing including: analyzing a table image representing a table to extract a plurality of objects included in the table; specifying a plurality of pairs each consisting of two objects selected from the extracted objects; performing set determination to determine whether or not the pairs are each a set constituting a component of the table; performing same-row determination to determine whether or not the objects of each of the pairs shares a same row; performing same-column determination to determine whether or not the objects of each of the pairs shares a same column; and determining a structure of the table by specifying a row and a column to which each of the objects belongs from a result of the set determination, a result of the same-row determination, and the a result of same-column determination.

A table-image recognition method according to an aspect of the disclosure includes: analyzing a table image representing a table to extract a plurality of objects included in the table; specifying a plurality of pairs each consisting of two objects selected from the extracted objects and performing set determination to determine whether or not the pairs are each a set constituting a component of the table; performing same-row determination to determine whether or not the objects of each of the pairs shares a same row; performing same-column determination to determine whether or not the objects of each of the pairs shares a same column; and determining a structure of the table by specifying a row and a column to which each of the objects belongs from a result of the set determination, a result of the same-row determination, and a result of the same-column determination.

According to one or more aspects of the disclosure, the correct structure of a complicated table can be acquired.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of a table-image recognition device according to a first embodiment;

FIG. 2 is a schematic diagram illustrating an example of an input table image;

FIG. 3 is a block diagram illustrating a hardware configuration example;

FIG. 4 is a flowchart illustrating the operation of performing set determination of objects;

FIG. 5 is a schematic diagram for explaining a set determination model, a same-row determination model, or a same-column determination model;

FIG. 6 is a block diagram schematically illustrating a configuration of a table-image recognition device according to a second embodiment.

### DETAILED DESCRIPTION OF THE INVENTION

### First Embodiment

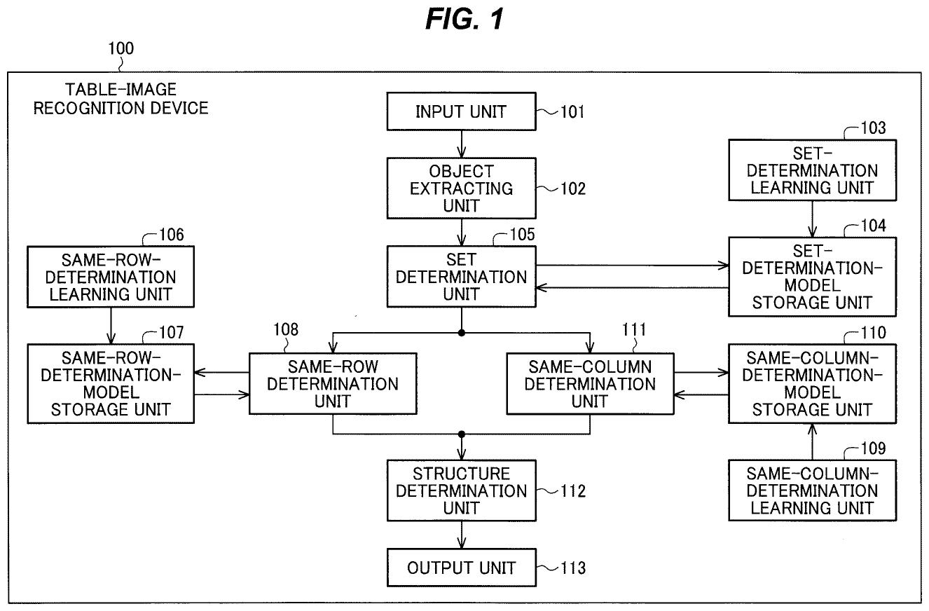

FIG. 1 is a block diagram schematically illustrating a configuration of a table-image recognition device 100 according to the first embodiment.

The table-image recognition device 100 includes an input unit 101, an object extracting unit 102, a set-determination learning unit 103, a set-determination-model storage unit 104, a set determination unit 105, a same-row-determination unit learning 106, a same-row-unit 107, a same-row determination-model storage determination unit 108, a same-column-determination learning unit 109, a same-column-determination-model storage unit 110, a same-column determination unit 111, a structure determining unit 112, and an output unit 113.

The input unit 101 accepts input of an image. Here, it is assumed that the input image is a table image showing a table. The input table image is given to the object extracting unit 102.

The object extracting unit 102 extracts table elements, or character string groups, figures, images, and the like, from the table image received from the input unit 101. Hereinafter, each of these elements is referred to as an “object.” In other words, the object extracting unit 102 extracts a plurality of objects included in the table shown in the table image. Object extraction is performed by estimating the coordinates indicating the position of a rectangular area circumscribing an object in the image and a label representing the object type. Here, the object label can be, but is not limited to, “character string,” “arrow,” “symbol,” or “image.”

For object extraction, for example, Mask R-CNN described in the following literature can be applied. Any other method may also be used for object extraction.

K. He, G. Gkioxari, P. Dollar, and R. Girshick; Mask R-CNN. Proceedings of the IEEE international conference on computer vision. 2017.

The object extracting unit 102 gives position information indicating the coordinates of the extracted objects and label information indicating the object labels to the set determination unit 105.

The set-determination learning unit 103 uses training data to learn a set determination model. The training data used here includes object pairs and truth data indicating whether each object pair is a set. An object is defined by position information indicating its coordinates and label information indicating its label. Hereinafter, this applies to objects. Here, the term “set” refers to a combination of elements that constitutes a single component, such as a pair of an image and a character string describing the content of the image or a pair of a symbol representing a milestone on a road map, which can be regarded as a type of table, and a character string describing the content of the symbol.

In other words, the set-determination learning unit 103 learns a set determination model, which is a learning model for performing set determination, by using training data including input data indicating learning pairs each consisting of two objects and truth data indicating whether or not the learning pairs are sets.

The set-determination-model storage unit 104 stores the set determination model learned by the set-determination learning unit 103.

The set determination unit 105 performs set determination by specifying multiple object pairs each consisting of two objects selected from the extracted objects and determining whether or not each of the object pairs is a set that constitutes a component of a table.

For example, the set determination unit 105 receives the position information and label information of each object in a table image from the object extracting unit 102 and performs binary classification on every object pair extracted by the object extracting unit 102 to classify whether the two objects of each object pair are a set by using the set determination model stored in the set-determination-model storage unit 104.

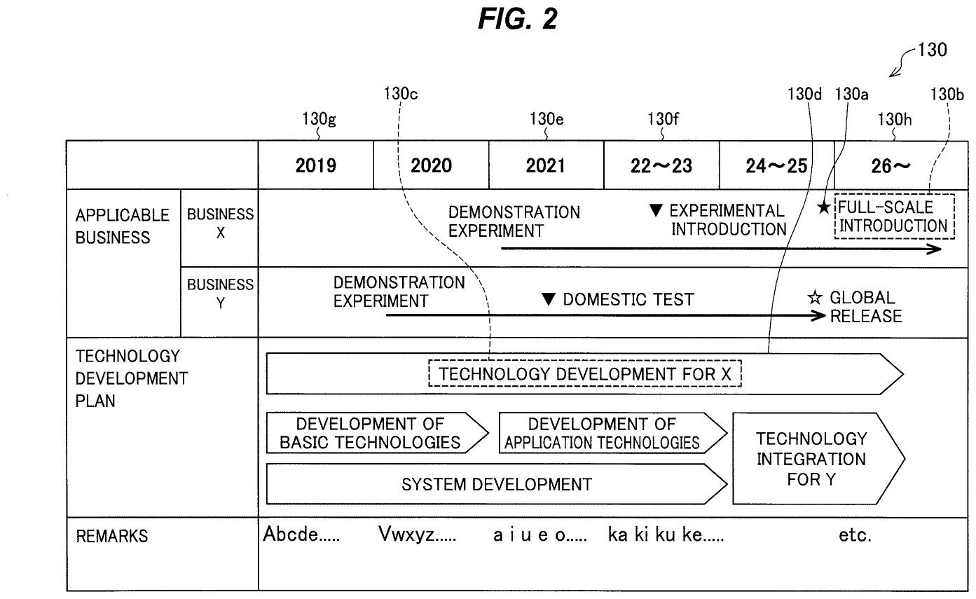

FIG. 2 is a schematic diagram illustrating an example of an input table image.

A table image 130 illustrated in FIG. 2 includes examples of object pairs that are sets, such as the pair consisting of a solid black star mark 130a and a character string 130b, “full-scale introduction,” the pair consisting of a character string 130c, “technology development for X,” and a box-shaped arrow 130d surrounding the character string 130c.

The set determination unit 105 may limit the combinations of object types to be determined on the basis of prior knowledge on the table image to be recognized, without determining every extracted object pair. For example, the sets in the road map illustrated in FIG. 2 are the pairs consisting of an arrow and a character string and the pairs consisting of a symbol, such as a star or a triangle, and a character string; therefore, the set determination unit 105 may exclude, from the targets of set determination, pairs consisting of the same type of objects and pairs consisting of an arrow and a symbol.

The set determination unit 105 then gives the object pairs and the set information indicating whether or not the object pairs are sets to the same-row determination unit 108 and the same-column determination unit 111.

Referring back to FIG. 1, the same-row-determination learning unit 106 uses training data to learn a same-row determination model. The training data used here includes object pairs and truth data indicating whether or not the objects of each object pair share a same row.

In other words, the same-row-determination learning unit 106 uses training data including input data indicating learning pairs each consisting of two objects and truth data indicating whether or not the objects of each learning pair share a same row, to learn a same-row determination model, which is a learning model for performing same-row determination.

The same-row-determination-model storage unit 107 stores the same-row determination model learned by the same-row-determination learning unit 106.

The same-row determination unit 108 performs same-row determination for determining whether or not the objects of each of the pairs described above share a same row.

For example, the same-row determination unit 108 receives position information and label information of each object in a table image from the object extracting unit 102, receives set information from the set determination unit 105, and uses the same-row determination model stored in the same-row-determination-model storage unit 107 to perform binary classification on every object pair extracted by the object extracting unit 102 to classify whether the two objects of each object pair share a same row.

Here, the same-row determination unit 108 excludes one of the two objects determined to be a set by the set determination unit 105 from being a target of same-row determination. Which one to be excluded should be determined on the basis of a pre-set rule based on the label type of the object.

The same-row determination unit 108 then gives, to the structure determining unit 112, the object pairs and the same-row information indicating whether or not the objects of each object pair share a same row.

The same-column-determination learning unit 109 learns a same-column determination model by using training data. The training data used here includes object pairs and truth data indicating whether or not the objects of each object pair share a same column.

In other words, the same-column-determination learning unit 109 uses training data including input data indicating learning pairs each consisting of two objects and truth data indicating whether or not the objects of each learning pair share a same column, to learn a same-column determination model, which is a learning model for performing same-column determination.

The same-column-determination-model storage unit 110 stores the same-column determination model learned by the same-column-determination learning unit 109.

The same-column determination unit 111 performs same-column determination for determining whether or not the objects of each of the pairs described above share a same column.

For example, the same-column determination unit 111 receives position information and label information of each object in a table image from the object extracting unit 102, receives set information from the set determination unit 105, and uses the same-column determination model stored in the same-column-determination-model storage unit 110 to perform binary classification on every object pair extracted by the object extracting unit 102 to classify whether the two objects of each object pair share a same column.

Here, the same-column determination unit 111 excludes one of the two objects determined to be a set by the set determination unit 105 from being a target of same-column determination. Which one to be excluded should be determined on the basis of a pre-set rule based on the label type of the object.

The same-column determination unit 111 then gives, to the structure determining unit 112, the object pairs and the same-column information indicating whether or not the objects of each object pair share a same column.

Here, in any of the three tasks of set determination, same-row determination, and same-column determination, the number of negative examples is significantly larger than the number of positive examples obtained from an ordinary table image, in other words, object pairs that are sets, object pairs each consisting of objects sharing a same row, or object pairs each consisting of objects sharing a same column. For this reason, instead of using every negative example, the negative examples may be randomly sampled, for example, to obtain the same number of negative examples as the positive examples, to learn a model.

The structure determining unit 112 specifies the rows and columns to which the extracted objects belong on the basis of the set determination results, the same-row determination results, and the same-column determination results, to determine the structure of a table shown in a table image.

For example, the structure determining unit 112 identifies the row and column to which each object extracted by the object extracting unit 102 belongs from the same-row information from the same-row determination unit 108 and the same-column information from the same-column determination unit 111.

The process of identifying the objects constituting a row can be performed, for example, as follows.

The structure determining unit 112 treats each object as a node and generates a node graph in which an edge is drawn between every two objects that share a same row. The structure determining unit 112 then specifies the maximal clique in the node graph. The objects corresponding to the nodes in each maximal clique are a set of objects constituting one row. The same applies to columns.

Here, a clique is a subgraph of the node graph in which edges reside between all nodes.

A maximal clique is a clique that is not included in other cliques out of the cliques of the node graph.

For an object that is determined to constitute a set by the set determination unit 105 and is excluded from being a subject of the determination process by the same-row determination unit 108 or the same-column determination unit 111, the structure determining unit 112 assumes that this object belongs to the same row or column as the other object of the set.

In other words, the same-row determination unit 108 determines that objects of a set pair, which is an object pair determined to be a set through the set determination, share a same row. One of the two objects of the set pair selected on the basis of a predetermined rule is used to specify the row to which the set pair belongs.

The same-column determination unit 111 also determines that the objects of the set pair share a same column. One of the two objects of the set pair selected on the basis of a predetermined rule is used to specify the column to which the set pair belongs.

In this way, a row or a column can be identified, not by the position or size of an object but by another object that constitutes a set with the object, and thus the table structure can be determined more correctly.

For example, in the table image 130 illustrated in FIG. 2, the character string 130c “Technology Development for X” can be determined to belong to two columns, the “2021” column 130e and the “22-23” column 130f if only the rectangular area surrounding the character string 130c is considered. However, in reality, the character string 130c belongs to six columns from the “2019” column 130g to the “26-” column 130h because of the surrounding box-shaped arrow 130d.

For this reason, the character string 130c “Technology Development for X” and the box-shaped arrow 130d surrounding the character string 130c are treated as a set of an object and a figure object, and only the arrow 130d is subjected to determination of a same row and a same column to correctly specify the rows and columns to which the character string 130c “Technology Development for X” belongs.

The structure determining unit 112 then determines the order of the rows and columns after specifying the set of objects constituting the rows and columns. The order can be specified by using, for example, the order of the average values of the positions of the objects constituting the rows and columns. The order of the rows and columns may also be determined by a method other than the method above.

Referring back to FIG. 1, the output unit 113 outputs information on the table structure obtained by the structure determining unit 112. The output format may be, for example, comma separated values (CSV) or extensible markup language (XML), or may be any other format.

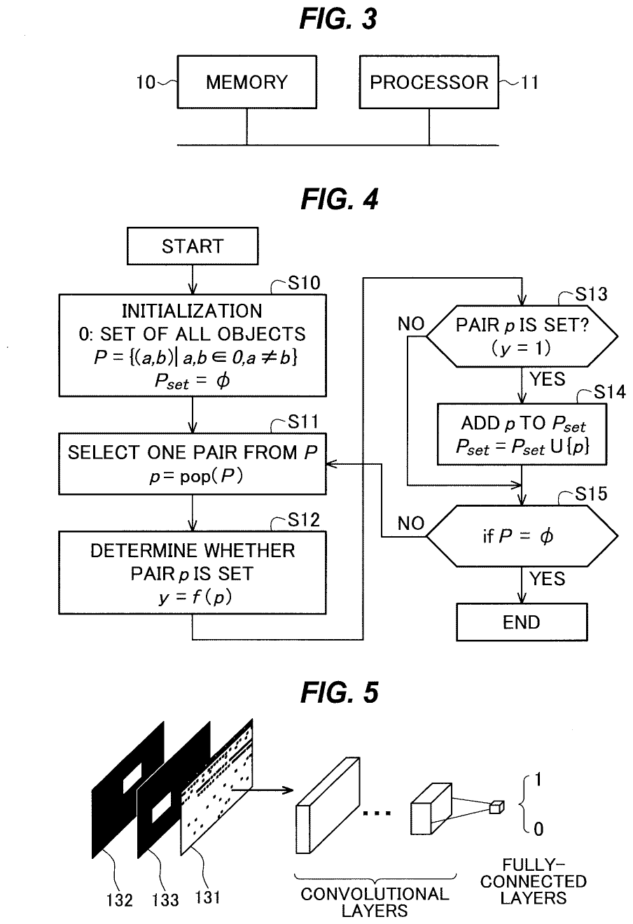

The input unit 101, the object extracting unit 102, the set-determination learning unit 103, the set determination unit 105, the same-row-determination learning unit 106, the same-row determination unit 108, the same-column-determination learning unit 109, the same-column determination unit 111, the structure determining unit 112, and the output unit 113 described above can be implemented by, for example, a memory 10 and a processor 11, such as a central processing unit (CPU), that executes the programs stored in the memory 10, as illustrated in FIG. 3. Such programs may be provided over a network or may be recorded and provided on a recording medium. That is, such programs may be provided, for example, as a program product. In other words, the table-image recognition device 100 can be implemented by what is commonly known as a computer.

The set-determination-model storage unit 104, the same-row-determination-model storage unit 107, and the same-column-determination-model storage unit 110 can be implemented by a storage, such as a hard disk drive (HDD) or a solid-state drive (SSD).

FIG. 4 is a flowchart illustrating the operation of the set determination unit 105 performing set determination of objects.

First, the set determination unit 105 generates a set P consisting of all object pairs and a set Pₛₑₜ that is an empty set from a set O consisting of all objects extracted by the object extracting unit 102 (step S10). Here, the set P is a set of pairs p, and each pair p includes objects a and b. Here, a≠b. As will be described later, it is also possible to narrow down number of the pairs to be subjected to determination on the basis prior knowledge. In this case, the set P is a set of pairs that are determination targets.

Next, the set determination unit 105 selects a pair p, which is an element, from the set P (step S11).

The set determination unit 105 then determines whether or not the objects a and b of the pair p is a set by inputting the objects a and b into the set determination model stored in the set-determination-model storage unit 104 (step S12).

If the pair p is determined to be a set (Yes in step S13), the set determination unit 105 causes the process to proceed to step S14, and if the pair p is not determined to be a set (No in step S13), the set determination unit 105 causes the process to proceed to step S15.

In step S14, the set determination unit 105 adds the pair p to the set Pₛₑₜ.

In step S15, the set determination unit 105 determines whether or not the set P is an empty set. If the set P is an empty set (Yes in step S15), the process ends, and if the set P is not an empty set (No in step S15), the process returns to step S11.

The set determination unit 105 then gives set information indicating the set Pₛₑₜ of the object pairs p that are sets obtained as described above to the same-row determination unit 108 and the same-column determination unit 111.

Examples that can be applied as the set determination model, the same-row determination model, or the same-column determination model includes a convolutional neural network that is trained to output “1” when the pair p=(a, b) is a set and in the same row or column, or otherwise to output “0,” where the input is an tensor obtained by superposing on an entire table image 131, mask images 132 and 133 having the same size as that of the entire table image 131 and having pixel values corresponding to labels only in areas of objects a and b and a pixel value 0 in the other areas, as illustrated in FIG. 5. With such a neural network, binary classification can be performed on the basis of whether the pair p is a set, in the same row, or in the same column. Here, for example, the table image 131 has three channels, and the mask images 132 and 133 each have one channel. The objects a and b that are determination targets are also referred to as “determination target objects.”

By inputting not only information on the labels and coordinates of the objects but also the entire table image 131 in this way, determination with higher accuracy can be achieved by using the relationship with surrounding elements or image information of the vicinity of the elements, even without information on the borders. The image information here is, for example, a difference in background colors or connecting lines indicating the relationships between elements.

### Second Embodiment

In the first embodiment, the set determination unit 105, the same-row determination unit 108, and the same-column determination unit 111 perform determination on the basis of the positions and label information of two objects and information on the original table image. However, if a character string is included in the objects to be determined, the content of the character string may be used for the set determination, the same-row determination, and the same-column determination. The second embodiment describes such an example.

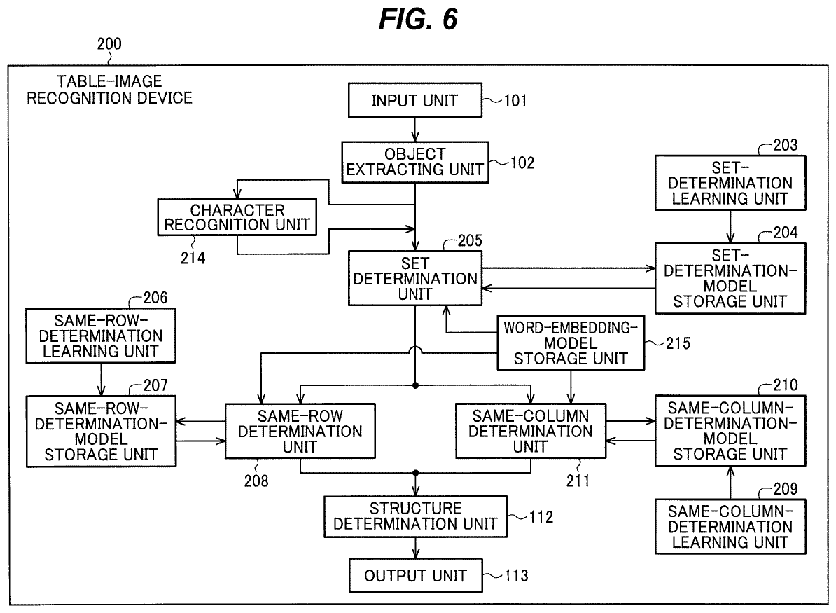

FIG. 6 is a block diagram schematically illustrating a configuration of a table-image recognition device 200 according to the second embodiment.

The table-image recognition device 200 includes an input unit 101, an object extracting unit 102, a set-determination learning unit 203, a set-determination-model storage unit 204, a set determination unit 205, a same-row-determination learning unit 206, a same-row-determination-model storage unit 207, a same-row determination unit 208, a same-column-determination learning unit 209, a same-column-determination-model storage unit 210, a same-column determination unit 211, a structure determining unit 112, an output unit 113, a character recognition unit 214, and a word-embedding-model storage unit 215.

The input unit 101, the object extracting unit 102, the structure determining unit 112, and the output unit 113 of the table-image recognition device 200 according to the second embodiment are respectively the same as the input unit 101, the object extracting unit 102, the structure determining unit 112, and the output unit 113 of the table-image recognition device 100 according to the first embodiment.

However, the object extracting unit 102 gives position information indicating the coordinates of extracted objects and label information indicating object labels to the set determination unit 205. The object extracting unit 102 gives position information indicating the coordinates of objects including character strings of the extracted objects to the character recognition unit 214.

The character recognition unit 214 performs character recognition on character string objects of the extracted objects.

For example, the character recognition unit 214 uses a known optical character recognition technique to recognize a character string in an object area indicated by the position information from the object extracting unit 102 in a table image input to the input unit 101, and generates recognized character-string information indicating the recognition result and the position of the recognized character string. The character recognition unit 214 then gives the recognized character-string information to the set determination unit 205.

The word-embedding-model storage unit 215 stores a word embedding model that is a vectorization model that transforms a character string into a vector as a feature. For the word embedding model, for example, word2vec can be used, or any other method may be used. The vector resulting from transformation is also referred to as an “embedded vector.”

The set-determination learning unit 203 uses training data to learn a set determination model. The training data used here includes object pairs and truth data indicating whether each object pair is a set.

In the second embodiment, when an object is a character string, the set-determination learning unit 203 learn the set determination model by inputting also a feature obtained by vectorizing the character string with the word embedding model stored in the word-embedding-model storage unit 215.

For example, the set-determination learning unit 203 uses training data including input data and truth data, to learn a set determination model, where the input data indicates learning pairs each consisting of two objects and features of the character strings when the objects included in the learning pairs are character strings, the truth data indicates whether or not the learning pairs are sets, and the set determination model is a learning model for performing set determination by also using the features of the character strings.

Specifically, the set-determination learning unit 203 learns the set determination model by using truth data as well as input data consisting of the learning pairs and embedded vectors transformed from the character strings included in the learning pairs.

The set-determination-model storage unit 204 stores the set determination model learned by the set-determination learning unit 203.

The set determination unit 205 uses the features obtained as a result of character recognition and the set determination model to perform set determination.

For example, the set determination unit 205 performs set determination by using the word embedding model stored in the word-embedding-model storage unit 215 to convert the results of character recognition by the character recognition unit 214 into embedded vectors (also referred to as “determination-target embedded vectors”) and inputting the embedded vectors to the set determination model.

Specifically, the set determination unit 205 receives the position information and label information of each object in a table image from the object extracting unit 102, receives recognized character information from the character recognition unit 214, and performs binary classification on every object pair extracted by the object extracting unit 102 to classify whether the two objects of each object pair are a set by using the set determination model stored in the set-determination-model storage unit 204.

The same-row-determination learning unit 206 uses training data to learn a same-row determination model. The training data used here includes object pairs and truth data indicating whether or not the objects of each object pair share a same row.

In the second embodiment, when an object includes a character string, the same-row-determination learning unit 206 learns the same-row determination model by also receiving input of a feature obtained by vectorizing the character string with the word embedding model stored in the word-embedding-model storage unit 215.

For example, the same-row-determination learning unit 206 uses training data including input data and truth data to learn a same-row determination model, where the input data indicates learning pairs each consisting of two objects and features of the character strings when the objects included in the learning pairs include character strings, the truth data indicates whether or not the learning pairs share a same row, and the same-row determination model is a learning model for performing same-row determination by also using the features of the character strings.

Specifically, the same-row-determination learning unit 206 learns the same-row determination model by using truth data as well as input data consisting of the learning pairs and embedded vectors transformed from the character strings included in the learning pairs.

The same-row-determination-model storage unit 207 stores the same-row determination model learned by the same-row-determination learning unit 206.

The same-row determination unit 208 uses features obtained as a result of character recognition by the character recognition unit 214 and the same-row determination model to perform same-row determination.

For example, the same-row determination unit 208 performs same-row determination by using the word embedding model stored in the word-embedding-model storage unit 215 to convert the results of character recognition into embedded vectors (also referred to as “determination-target embedded vectors”) and inputting the embedded vectors to the same-row determination model.

Specifically, the same-row determination unit 208 receives position information and label information of each object in a table image from the object extracting unit 102, receives set information from the set determination unit 205, receives recognized character information from the character recognition unit 214, and uses the same-row determination model stored in the same-row-determination-model storage unit 207 to perform binary classification on every object pair extracted by the object extracting unit 102 to classify whether the two objects of each object pair share a same row.

Here, the same-row determination unit 208 excludes one of the two objects determined to be a set by the set determination unit 205 from being a target of same-row determination. Which one to be excluded should be determined on the basis of a pre-set rule based on the label type of the object.

The same-row determination unit 208 then gives, to the structure determining unit 112, the object pairs and the same-row information indicating whether or not the objects of each object pair share a same row.

The same-column-determination learning unit 209 learns a same-column determination model by using training data. The training data used here includes object pairs and truth data indicating whether or not the objects of each object pair share a same column.

In the second embodiment, when an object includes a character string, the same-column-determination learning unit 209 learns the same-column determination model by also receiving input of a feature obtained by vectorizing the character string with the word embedding model stored in the word-embedding-model storage unit 215.

For example, the same-column-determination learning unit 209 uses training data including input data and truth data to learn a same-column determination model, where the input data indicates learning pairs each consisting of two objects and features of the character strings when the objects included in the learning pairs include character strings, the truth data indicates whether or not the learning pairs share a same column, and the same-column determination model is a learning model for performing same-column determination by also using the features of the character strings.

Specifically, the same-column-determination learning unit 209 learns the same-column determination model by using truth data as well as input data consisting of the learning pairs and embedded vectors transformed from the character strings included in the learning pairs.

The same-column-determination-model storage unit 210 stores the same-column determination model learned by the same-column-determination learning unit 209.

The same-column determination unit 211 uses features obtained as a result of character recognition by the character recognition unit 214 and the same-column determination model to perform same-column determination.

For example, the same-column determination unit 211 performs same-column determination by using the word embedding model stored in the word-embedding-model storage unit 215 to convert the results of character recognition into embedded vectors (also referred to as “determination-target embedded vectors”) and inputting the embedded vectors to the same-column determination model.

Specifically, the same-column determination unit 211 receives position information and label information of each object in a table image from the object extracting unit 102, receives set information from the set determination unit 205, receives recognized character information from the character recognition unit 214, and uses the same-column determination model stored in the same-column-determination-model storage unit 210 to perform binary classification on every object pair extracted by the object extracting unit 102 to classify whether the two objects of each object pair share a same column.

Here, the same-column determination unit 211 excludes one of the two objects determined to be a set by the set determination unit 205 from being a target of same-column determination. Which one to be excluded should be determined on the basis of a pre-set rule based on the label type of the object.

The same-column determination unit 211 then gives, to the structure determining unit 112, the object pairs and the same-column information indicating whether or not the objects of each object pair share a same column.

Each of the set determination model, the same-row determination model, and the same-column determination model can perform determination by using character string information by, for example, replacing the network illustrated in FIG. 5 with a network that uses, as input, a feature obtained by superposing the final output of the convolutional layers on the embedded vector of the character recognition result of the two objects and outputs a scalar value within the range of zero to one as a classification result.

As described above, the second embodiment can perform set determination, same-row determination, and same-column determination with high accuracy, so that structured information can be extracted from a table image more accurately.

1. A table-image recognition device comprising:
a processor to execute a program; and
a memory to store the program which, when executed by the processor, performs processes of,
analyzing a table image representing a table to extract a plurality of objects included in the table;
specifying a plurality of pairs each consisting of two objects selected from the extracted objects;
performing set determination to determine whether or not the pairs are each a set constituting a component of the table;
performing same-row determination to determine whether or not the objects of each of the pairs shares a same row;
performing same-column determination to determine whether or not the objects of each of the pairs shares a same column; and
determining a structure of the table by specifying a row and a column to which each of the objects belongs from a result of the set determination, a result of the same-row determination, and a result of the same-column determination.

2. The table-image recognition device according to claim 1, wherein,
the processor determines that objects of a set pair share a same row, the set pair being a pair determined to be a set through the set determination, and
the processor determines that the objects of the set pair share a same column.

3. The table-image recognition device according to claim 1 wherein,
the processor learns a set determination model by using training data including input data and truth data, the set determination model being a learning model that performs the set determination, the input data indicating a learning pair consisting of two objects, the truth data indicating whether or not the learning pair is a set; and
the processor uses the set determination model to perform the set determination.

4. The table-image recognition device according to claim 3, wherein,
the processor specifies a position and a type of each of the objects, and
the set determination model is a model that performs binary classification to classify whether two determination target objects subjected to the set determination are a set through a neural network receiving a tensor as input, the tensor being obtained by superposing two mask images and the table image, the two mask images having pixel values for areas corresponding to the positions of the two determination target objects, the pixel values indicating the types of the two determination target objects.

5. The table-image recognition device according to claim 1, wherein,
the processor learns a set determination model by using training data including input data and truth data, the set determination model being a learning model that performs the set determination, the input data indicating a learning pair consisting of two objects and a feature of a character string when one or more of the objects of the learning pair is a character string, the truth data indicating whether or not the learning pair is a set, the set-determination learning unit also using the feature of the character string to learn the set determination model;
the processor performs character recognition on a character string object of the plurality of objects; and
the processor uses a feature obtained as a result of the character recognition and the set determination model to perform the set determination.

6. A table-image recognition device according to claim 5, wherein,
the processor learns the set determination model by using the input data and the truth data, the input data indicating the learning pair and an embedded vector converted from the character string included in the learning pair, the determination-target embedded vector being an embedded vector, and
the set determination unit performs the set determination by using a word embedding model to convert a result of the character recognition into the determination-target embedded vector and inputting the determination-target embedded vector to the set determination model.

7. The table-image recognition device according to claim 1, wherein,
the processor learns a same-row determination model by using training data including input data and truth data, the same-row determination model being a learning model that performs the same-row determination, the input data indicating a learning pair consisting of two objects, the truth data indicating whether or not the objects of the learning pair share a same row; and
the processor uses the same-row determination model to perform the same-row determination.

8. The table-image recognition device according to claim 7, wherein,
the processor specifies a position and a type of each of the objects, and
the same-row determination model is a model that performs binary classification to classify whether two determination target objects which are two object subjected to the same-row determination share a same row through a neural network receiving a tensor as input, the tensor being obtained by superposing two mask images and the table image, the two mask images having pixel values for areas corresponding to the positions of the two determination target objects, the pixel values indicating the types of the two determination target objects.

9. The table-image recognition device according to claim 1, wherein,
the processor learns a same-row determination model by using training data including input data and truth data, the same-row determination model being a learning model that performs the same-row determination, the input data indicating a learning pair consisting of two objects and a feature of a character string when one or more of the objects of the learning pair is a character string, the truth data indicating whether or not the objects of the learning pair share a same row, the same-row-determination learning unit also using the feature of the character string to learn the same-row determination model;
the processor performs character recognition on a character string object of the plurality of objects; and
the processor uses the feature obtained as a result of the character recognition and the same-row determination model to perform the same-row determination.

10. The table-image recognition device according to claim 9, wherein,
the processor learns the same-row determination model by using input data and the truth data, the input data indicating the learning pair and an embedded vector converted from the character string included in the learning pair, the determination-target embedded vector being an embedded vector, and
the processor performs the same-row determination by using a word embedding model to convert a result of the character recognition into the determination-target embedded vector and inputting the determination-target embedded vector to the same-row determination model.

11. The table-image recognition device according to claim 1, wherein,
the processor learns a same-column determination model by using training data including input data and truth data, the same-column determination model being a learning model that performs the same-column determination, the input data indicating a learning pair consisting of two objects, the truth data indicating whether or not the objects of the learning pair share a same column; and
the processor uses the same-column determination model to perform the same-column determination.

12. The table-image recognition device according to claim 11, wherein,
the processor specifies a position and a type of each of the objects, and
the same-column determination model is a model that performs binary classification to classify whether two determination target objects which are two objects subjected to the same-column determination share a same column through a neural network receiving a tensor as input, the tensor being obtained by superposing two mask images and the table image, the two mask images having pixel values for areas corresponding to the positions of the two determination target objects, the pixel values indicating the types of the two determination target objects.

13. The table-image recognition device according to claim 1, wherein,
the processor learns a same-column determination model by using training data including input data and truth data, the same-column determination model being a learning model that performs the same-column determination, the input data indicating a learning pair consisting of two objects and a feature of a character string when one or more of the objects of the learning pair is a character string, the truth data indicating whether or not the objects of the learning pair share a same column, the same-column-determination learning unit also using the feature of the character string to learn the same-column determination model;
the processor performs character recognition on a character string object of the plurality of objects; and
the processor uses the feature obtained as a result of the character recognition and the same-column determination model to perform the same-column determination.

14. The table-image recognition device according to claim 13, wherein,
the processor learns the same-column determination model by using input data and the truth data, the input data indicating the learning pair and an embedded vector converted from the character string included in the learning pair, the determination-target embedded vector being an embedded vector, and
the processor performs the same-column determination by using a word embedding model to convert a result of the character recognition into the determination-target embedded vector and inputting the determination-target embedded vector to the same-column determination model.

15. A non-transitory computer-readable storage medium storing a program that causes a computer to execute processing comprising:
analyzing a table image representing a table to extract a plurality of objects included in the table;
specifying a plurality of pairs each consisting of two objects selected from the extracted objects;
performing set determination to determine whether or not the pairs are each a set constituting a component of the table;
performing same-row determination to determine whether or not the objects of each of the pairs shares a same row;
performing same-column determination to determine whether or not the objects of each of the pairs shares a same column; and
determining a structure of the table by specifying a row and a column to which each of the objects belongs from a result of the set determination, a result of the same-row determination, and a result of the same-column determination.

16. A table-image recognition method comprising:
analyzing a table image representing a table to extract a plurality of objects included in the table;
specifying a plurality of pairs each consisting of two objects selected from the extracted objects and performing set determination to determine whether or not the pairs are each a set constituting a component of the table;
performing same-row determination to determine whether or not the objects of each of the pairs shares a same row;
performing same-column determination to determine whether or not the objects of each of the pairs shares a same column; and
determining a structure of the table by specifying a row and a column to which each of the objects belongs from a result of the set determination, a result of the same-row determination, and a result of the same-column determination.

17. The table-image recognition device according to claim 2, wherein,
the processor learns a set determination model by using training data including input data and truth data, the set determination model being a learning model that performs the set determination, the input data indicating a learning pair consisting of two objects and a feature of a character string when one or more of the objects of the learning pair is a character string, the truth data indicating whether or not the learning pair is a set, the set-determination learning unit also using the feature of the character string to learn the set determination model;
the processor performs character recognition on a character string object of the plurality of objects; and
the processor uses a feature obtained as a result of the character recognition and the set determination model to perform the set determination.
